(19) United States
(12) Patent Application Publication
(10) Pub. No.: US 2019/0150541 A1
(43) Pub. Date: May 23, 2019

(54) INFINITY QUILTING

(71) Applicant: The North Face Apparel Corp., Wilmington, DE (US)

(72) Inventor: Luk Kin Man, Sham Tseng (HK)

(21) Appl. No.: 16/197,672

(22) Filed: Nov. 21, 2018

Related U.S. Application Data
(60) Provisional application No. 62/589,815, filed on Nov. 22, 2017.

(51) Int. Cl. A41D 31/02; B32B 5/02; B32B 5/06; B32B 5/26

(52) U.S. Cl. CPC A41D 31/02; B32B 5/024; B32B 5/06; A41D 2400/10; B32B 2437/00; A41D 2500/20; B32B 5/26

(57) ABSTRACT

Article, such as quilted construction, and methods of making the same are described. A quilted construction may comprise a first woven sheet, a second woven sheet, a series of stitching, a reinforcing body, and a thermally insulating filler. The first woven sheet may be coupled to the second woven sheet via a series of stitching to define one or more chambers. The reinforcing body may have a figure-eight form and may be disposed between the first woven sheet and second woven sheet such that a crossover of the figure-eight form is aligned with the series of stitching. The thermal insulating filler may be disposed within the one or more chambers.

### CROSS-REFERENCE TO RELATED APPLICATION

The present application claims priority to and the benefit of U.S. Patent Application Ser. No. 62/589,815, entitled “Infinity Quilting” (filed Nov. 22, 2017), the entirety of which application is incorporated herein by reference for any and all purposes.

### FIELD

The present disclosure relates to garment constructions, in particular quilted garment constructions.

### BACKGROUND

Thermal insulation is often a desired characteristic of quilted garments. For quilted clothing to protect against low temperatures, this apparel often includes insulating material such as down. Optimizing insulation efficiency of quilted apparel can render the apparel warmer and more comfortable to wear. Quilted down styles increasingly incorporate lighter and thinner fabric for wearability. These styles may also feature intricate quilting for design purposes. With thinner fabric, quilted constructions of the prior art may suffer from down leakage. This may reduce the insulating efficiency of the garment for a wearer. Moreover, escaping down may diminish aesthetic appeal of the garment. As such, improvements in quilted garment construction as well as in other articles of clothing are needed.

### SUMMARY

The present disclosure relates to garment constructions, in particular quilted garment constructions. A construction may comprise a first layer; a second layer disposed adjacent the first layer such that the second layer is generally parallel to the first layer; a plurality of tubular inserts disposed between the first layer and the second layer; and a plurality of stitches configured to join at least a portion of the first layer to at least a portion of the second layer, wherein at least a portion of the plurality of stitches pass through the plurality of tubular inserts such that the plurality of tubular inserts form a plurality of curvilinear cross-sectional bodies, and wherein the plurality of stitches, the first and second layers, and the plurality of curvilinear cross-sectional bodies define a plurality of chambers between the first layer and the second layer; and a thermal insulation material disposed within the plurality of chambers.

In further aspects, the disclosure relates to a fabric structure comprising a first woven sheet; a second woven sheet; a series of stitching affixing at least a portion of the first woven sheet to a portion of the second woven sheet and defining one or more chambers between the first woven sheet and the second woven sheet; a reinforcing body having a figure-eight form. The reinforcing body may be disposed between the first woven sheet and second woven sheet such that a crossover of the figure-eight form is aligned with the series of stitching. A thermal insulating filler may be disposed within the one or more chambers.

Methods are also disclosed. A method of quilting may comprise affixing a tubular body to a first fabric layer of a plurality of fabric layers via a series of stitching. The affixing the tubular body to the first layer may form a generally curvilinear cross-sectional body at the first layer. A second fabric layer of the plurality of layers may be affixed to the first layer and the generally curvilinear cross-sectional body via a second series of stitching wherein the second series of stitching is configured to passed through (i.e., sewn-through) the first fabric layer, the second fabric layer and the formed generally curvilinear cross-sectional body. The fabric layers, series of stitching, and generally lemniscate body may define a volume. A generally lemniscate body may describe a body having a plane curve with a characteristic shape, having two loops that meet at a central point as in a figure eight. At least a portion of a perimeter of the first layer and a perimeter of the second layer may be joined to form an enclosure, wherein the enclosure includes the volume. A fill material may be disposed at the enclosure such that at least a portion of the volume is filled.

Other aspects relate to a garment comprising: a first pliable sheet-like structure; a second pliable sheet-like structure disposed adjacent the first pliable sheet-like structure. The second pliable sheet-like structure may be coupled to the first pliable sheet-like structure via stitching. One or more generally figure-eight cross-sectional bodies may be disposed between the first sheet-like structure and the second sheet-like structure wherein the generally figure-eight cross-sectional body may be affixed to the first sheet-like structure and the second sheet-like structure via stitching. The first sheet-like structure, the second sheet-like structure, and the one or more generally figure-eight cross-sectional bodies may form a plurality of chambers. The stitching may form a cross-over of the generally figure-eight cross-sectional body. A thermal insulating material may be disposed in at least a portion of the chambers of the plurality of chambers.

The disclosure further relates to a construct, comprising a first pliable sheet material opposite to a second pliable sheet material, a series of stitching joining the first pliable sheet material to the second pliable sheet material. The series of stitching may define a volume for receiving a loose fill material. A reinforcing body may be disposed at the series of stitching and between the first pliable sheet material and the second pliable sheet material, wherein the reinforcing body has a curvilinear cross-sectional form. A fill material may be disposed within the volume.

In further aspects, the disclosure relates to a stitching reinforcement device comprising a tubular insert or a tubular body. Tubular body as described herein may refer to a configuration of the stitching reinforcement device (or reinforcing body as provided above) having a hollow cylindrical structure with distal ends. The tubular body may be hollow or substantially hollow in that its structure allows passage there through from one end to another. The tubular body may be configured to be affixed between generally parallel fabric layers. The tubular body may be affixed via stitching so that when the tubular body is disposed between the generally parallel fabric layers the tubular body assumes a generally figure-eight cross-sectional body. A cross-section of the figure-eight cross-sectional may be aligned with the stitching joining the fabric layers.

There has thus been outlined, certain embodiments of the present disclosure in order that the detailed description thereof herein may be better understood, and in order that the present contribution to the art may be better appreciated. There are, of course, additional embodiments of the disclosure that will be described below and which will form the subject matter of the claims appended hereto.

Attached to and submitted with this specification as part of this application are Appendix A and B of presentations including images related to the present disclosure. The Attachments and Appendices to this application are incorporated herein and deemed to be part of the application as if otherwise incorporated. The specific compositions and other features disclosed in these Attachments and Appendices, and obvious extensions thereof, are considered to be additional embodiments of the present disclosure as if specifically described in the body of the specification. Upon allowance of this application, the appendix may be deleted if authorized by Applicants or their representative, to remain part of the file, and need not be printed with any patent that may issue.

### BRIEF DESCRIPTION OF THE DRAWINGS

In order to facilitate a fuller understanding of the disclosure, reference is now made to the accompanying drawings, in which like elements are referenced with like numerals. These drawings should not be construed as limiting the disclosure and intended only to be illustrative.

FIG. 1 is a cross-sectional perspective view of a portion of a quilted construction in accordance with aspects of the present disclosure.

FIG. 2 is a detailed cross-sectional perspective view of the portion of the quilted construction shown in FIG. 1.

FIG. 3 is a top perspective view of the quilted construction shown in FIG. 1, illustrating stitching of the quilting construction.

FIGS. 4A-4C are perspectives of a reinforcing body of the quilted construction shown in FIG. 1 providing a top view 4A, a perspective view 4B, and a cross-sectional view 4C.

FIG. 5 is a cross-sectional image of a quilted construction in accordance with FIG. 1.

FIG. 6 is a schematic diagram for a method of forming a quilted construction in accordance with FIG. 1.

FIGS. 7A-7C are a series of images depicting the steps of forming a quilted construction in accordance with FIG. 1.

FIGS. 8A-8D are a schematic diagram depicting a method of forming a quilted construction in accordance with FIG. 1.

FIGS. 9A-9D are a schematic diagram depicting a method of forming a quilted construction having a checker-board design in accordance with aspects of the present disclosure.

FIGS. 10A-10C are images depicting results for down leakage for a conventional quilted construction (FIG. 10A) and for quilted constructions prepared in accordance with FIG. 1 (FIG. 10B and FIG. 10C).

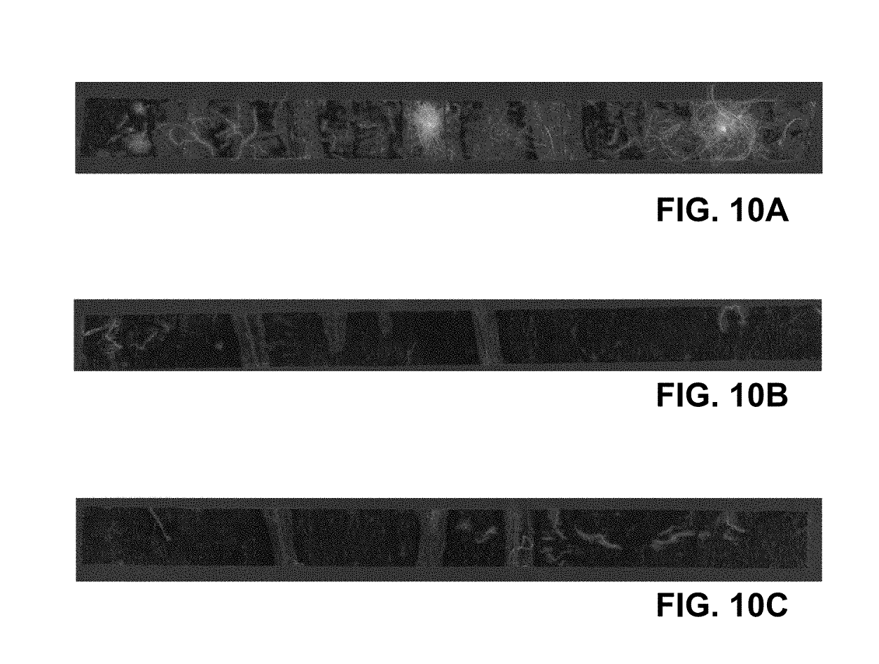

### DETAILED DESCRIPTION

Conventional quilting methods generally feature stitching of a quilting line through an outer layer (i.e., a shell) of a garment or a cover for an insulation material, such as down, to be contained or enclosed. Recently, quilted down garments, apparel, or other goods incorporate lighter or thinner fabric for the layers to improve wearability. These quilted down constructions may also feature complicated or more intricate quilting to provide better hand feel and to meet certain design or aesthetic requirements. As the fabric becomes thinner and the stitching more intricate, the friction force provided by the fabric to limit down leakage from stitching needle holes becomes a concern. Intricate quilting styles may also increase the likelihood of down fill being pulled out by stitching during normal use. Quilted constructions of the present disclosure may reduce down fill leakage at the stitching.

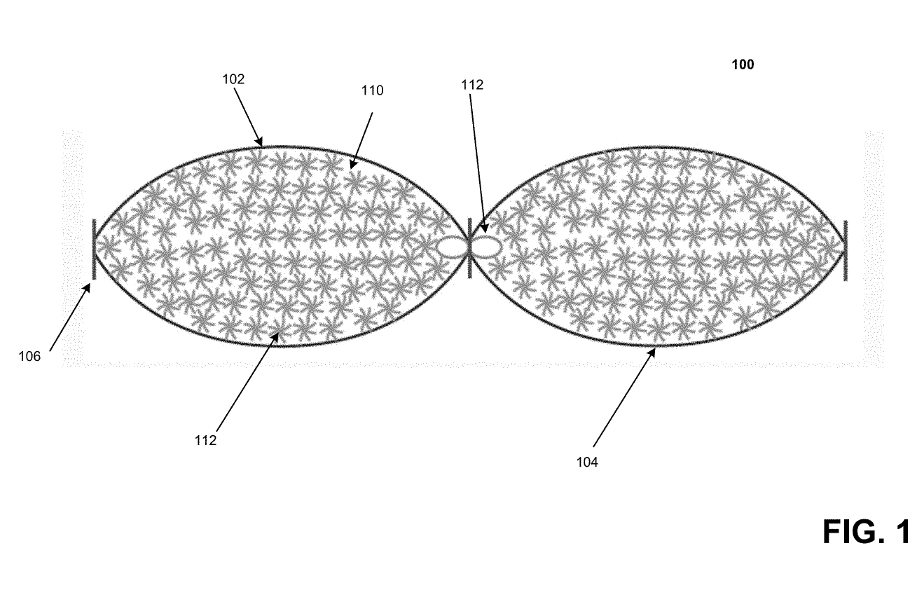

FIGS. 1-3 illustrate an article 100 such as a quilted construction. As an example, various articles, such as the article 100, may comprise a first pliable sheet-like structure, a second pliable sheet-like structure, stitching, a generally figure-eight cross-sectional body, and a thermal insulating material. The first pliable sheet-like structure may be adjacent the second pliable sheet-like structure. The second pliable sheet-like structure may be coupled to the first pliable sheet-like structure via the stitching. The stitching and the first and second sheet-like structures cooperate to define one or more chambers within which the thermal insulating material is disposed. One or more generally figure-eight cross-sectional bodies may be disposed between the first sheet-like structure and the second sheet-like structure at the stitching. The generally figure-eight cross-sectional body is affixed to the first sheet-like structure and the second sheet-like structure via stitching. Thus, the first sheet-like structure, the second sheet-like structure, the stitching, and the one or more generally figure-eight cross-sectional bodies cooperate to define the plurality of chambers. The stitching may define a crossover of the generally figure-eight cross-sectional body.

FIG. 1 is a cross-sectional view of the article 100 in accordance with aspects of the present disclosure. The article 100 may comprise a quilted construction, such as a garment or other apparel item. As shown, the article 100 may comprise a first pliable sheet-like material (also described herein as a first layer) 102. The first pliable sheet-like material 102 may be coupled to a second pliable sheet-like material 104 via a series of stitching 106. The stitching 106 may define one or more chambers (also described herein as volumes) 110 enclosed by the first and second pliable sheet-like materials 102, 104. A figure-eight cross-sectional body 112 may be disposed at the stitching 106 that couples the first and second pliable sheet-like materials 102, 104. A thermal insulating material 114 may be disposed at the one or more chambers 110.

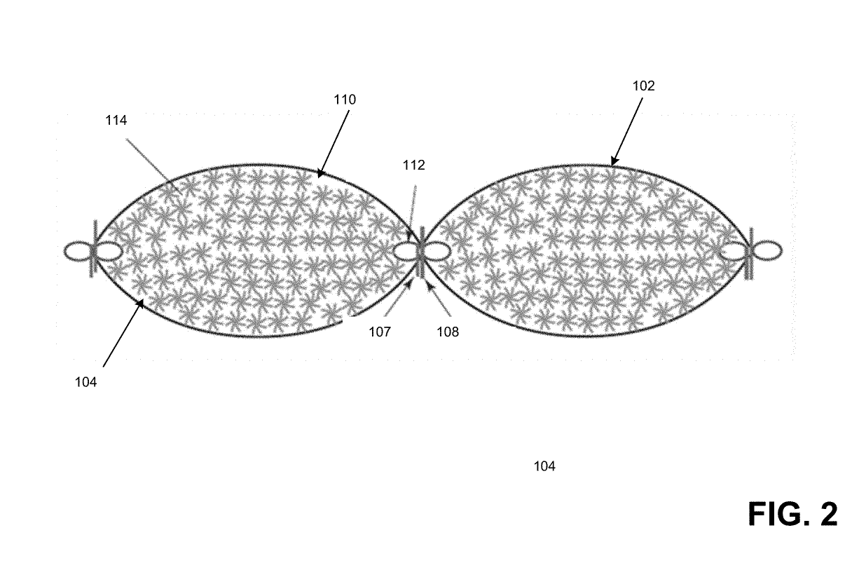

FIG. 2. is more detailed cross-sectional view of the article 100, shown in FIG. 1 and illustrates how the article 100 may be formed. The article 100 may comprise a first pliable sheet-like material or first layer 102. The first layer 102 may be coupled to a second layer 104 and to a reinforcing body 106 via a first and second series of stitching 107, 108. In certain aspects, the first layer 102 may be coupled to the reinforcing body 112 via a first plurality of stitching 107 such that the reinforcing body 112 assumes a generally curvilinear cross-sectional or figure-eight form. The figure-eight form is apparent when viewed as a cross-section along a longitudinal axis of the reinforcing body 112. The first layer 102 and the reinforcing body 112 may be coupled or affixed to a second layer 104 via a second plurality of stitching 108. The first and second layers 102, 104, the first and second plurality of stitching 107, 108, and the reinforcing body 112 cooperate to define one or more volumes 110. A fill material 114 may be disposed within the defined volume 110.

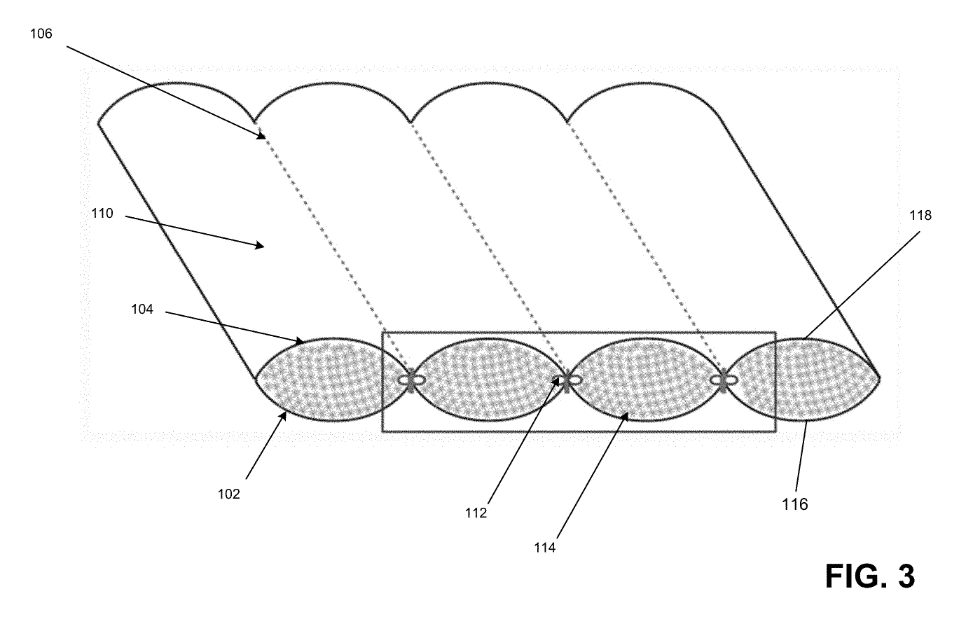

FIG. 3. is a top perspective view of the quilted construction shown in FIG. 1, illustrating stitching of the quilting construction along a surface of the second layer. The article 100 may comprise a first layer 102 disposed adjacent a second layer 104 such that the first and second layers 102, 104 are generally parallel to one another. A plurality of stitches 106 may be configured to couple at least a portion of the first layer 102 to at least a portion of the second layer 104. The plurality of stitches 106 may extend from a first end of the first layer 116 and a first end of the second layer 118 and traverse (pass through, or is sewn-through) a length of the layers 102, 104. The reinforcing body 112 may be disposed between the first and second layers 102, 104 along the plurality of stitches 106 which couple the first and second layers 102, 104 together. The first layer 102, second layer 104, plurality of stitches 112106 and the reinforcing body 112 define one or more chambers 110. The one or more chambers 110 may extend along the plurality of stitches 106 and reinforcing body 112. A fill material 114 may be disposed within the one or more chambers 110.

In FIG. 3, a cross-section of the reinforcing body 112 is apparent but the remainder of the body 106 is obscured between the first and second layers 102, 104. The reinforcing body 112 however follows the plurality of stitching 106. The plurality of stitching 106 causes the reinforcing body 112 to have a generally curvilinear cross-sectional or figure-eight form.

In certain aspects, the present disclosure relates to a stitching reinforcement device, i.e., a reinforcing body as described herein. Multiple reinforcing bodies may be affixed between parallel fabric layers in a given quilted construction. The reinforcing body may comprise a tubular insert or body. The tubular body may be configured to be affixed between parallel fabric layers. The tubular body may be affixed to the fabric layers via stitching so that when the tubular body is disposed between the parallel fabric layers the tubular body assumes a generally figure-eight cross-sectional body. A longitudinal cross-section of the figure-eight cross-sectional may align with the stitching joining the fabric layers as the stitching traverses the parallel fabric layer and the reinforcing body.

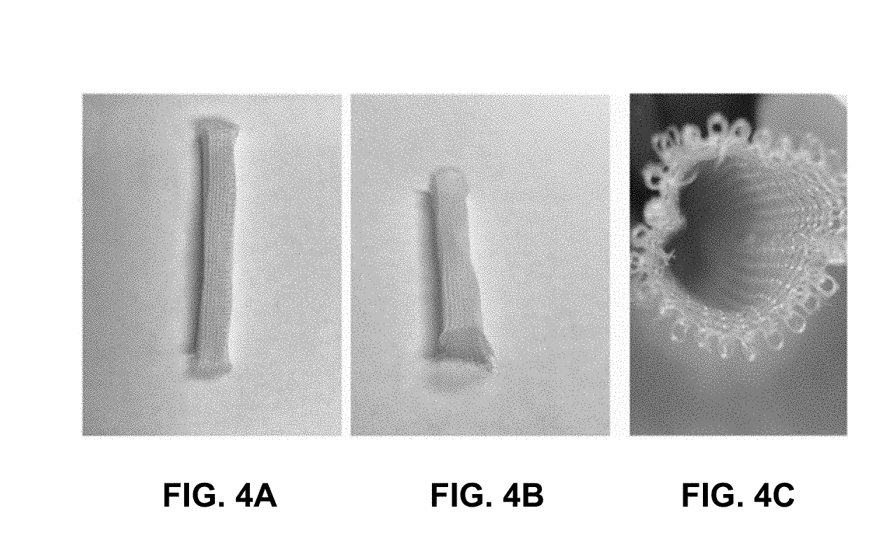

FIGS. 4A-4C present varying perspectives of a reinforcing body according to the present disclosure. In some aspects aspect, for example, the reinforcing body comprises a tubular insert or a similarly configured pipe-shaped body, cylindrical body, or cylindrical ribbon. FIG. 4A is a top view of the reinforcing body as a tubular insert. FIG. 4B is a perspective view of the tubular insert. FIG. 4C is a cross-sectional view of the reinforcing body as a tubular insert. As an example, the tubular body may be a substantially hollow body. The tubular insert may comprise a sufficiently pliable material. The sufficiently pliable material allows the tubular insert to be coupled via stitching to a first layer of the quilted construction such that the tubular insert assumes a generally figure-eight form.

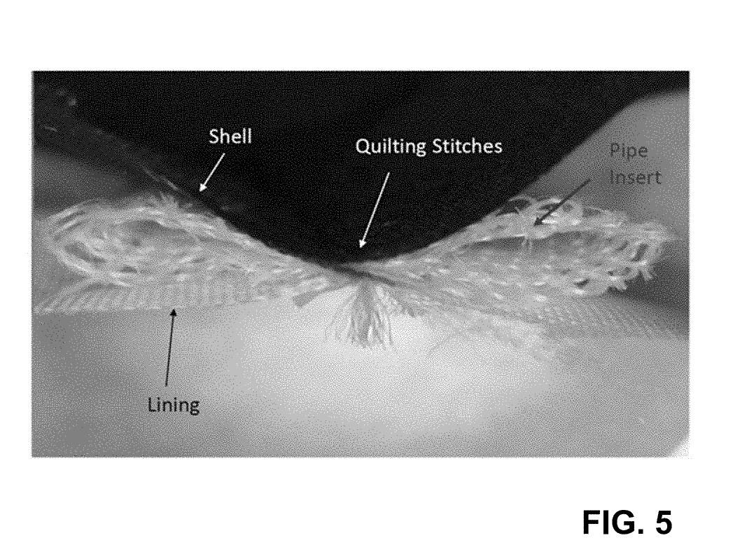

In the assumed figure-eight form, the reinforcing body may be characterized by a longitudinal crossover section and two uniplanar lobes extending along a length of the body. The figure-eight form may be disposed between the coupled first and second pliable sheets (or layers) such that stitching forms the longitudinal crossover section of the figure-eight form. Within the quilted construction, each of the lobes may extend into adjacent chambers. FIG. 5 is an image of a portion of a quilted construction illustrating the stitching of the reinforcing body to the first and second layers. As shown, the reinforcing body (comprising a sufficiently pliable material) is disposed between a first layer (lining) and a second layer (shell) such that the reinforcing body has a generally figure-eight form. Quilting stitches traverse (or are sewn-through) the lining, reinforcing body, and shell forming two lobes on either side of the quilting stitches.

As described herein, the reinforcing body comprises a sufficiently pliable material or textile. Desirably, the reinforcing body comprises a material that allows the body to be compressed (along its length) between the first and second layers of the quilted construction. Furthermore, the reinforcing body comprises a material that permits coupling or affixing to the first and second layers of the quilted construction. In certain aspects, the reinforcing body comprises a material that may be sewn through so as to couple, adhere, or affix the reinforcing body to layers of the quilted construction. Various materials or fabrics may be suitable. As an example, the reinforcing body may comprise a mesh material or fabric. For example, the reinforcing body may comprise a nylon (polyamide) mesh.

In various aspects, the first and/or second layers described herein may comprise a fabric. In some aspects, the first and second layers may comprise a sheet, a shell, or a lining. The layers may comprise a fabric, such as a woven fabric. In further examples, the layers may comprise a thermoplastic fabric such as a polyamide fabric. The fabric may be sufficiently penetrable to accommodate stitching, such as quilt stitching, therethrough.

In a garment, for example, the first layer to which the reinforcing body is attached or affixed may comprise a lining. That is, where the quilted construction is a wearable garment, the first layer may comprise a lining material. A number of lining materials are known in the art for quilted garments. The second layer, which is coupled to the reinforcing body and the first layer, may comprise a shell fabric for example. A number of shell fabric materials, such as nylon, are known in the art for quilted garments.

Stitching, or the plurality of stitches described herein, may refer to quilt stitching. The stitching may be used to join or affix the layers of fabric to the reinforcing body. Stitching may be achieved via a number of methods or devices used in the art. In certain aspects, the present disclosure includes stitching performed by an automatic quilting machine or an embroidery machine or device. Use of an automatic quilting machine, embroidery machine or similar device, rather than a conventional sewing machine may enable more precise or improved affixing. For example, using an embroidery machine may allow for the first series of stitching (affixing the reinforcing body to the first layer) and the second series of stitching (affixing the reinforcing body and the first and second layers) to overlap or to substantially overlap. The first and second series of stitching may be aligned using an embroidery machine. That is, the first and second series of stitching may be aligned one on top of the other using an embroidery machine or first and second series of stitching may be aligned such that second series of stitching is disposed adjacent the first series of stitching.

Thermal insulating material as used herein may describe a number of fill materials known in the art. In some examples, the thermal insulating material may comprise down, poly-fill, fiber ball, or a combination thereof. Down generally refers to insulative material, most commonly animal feathers.

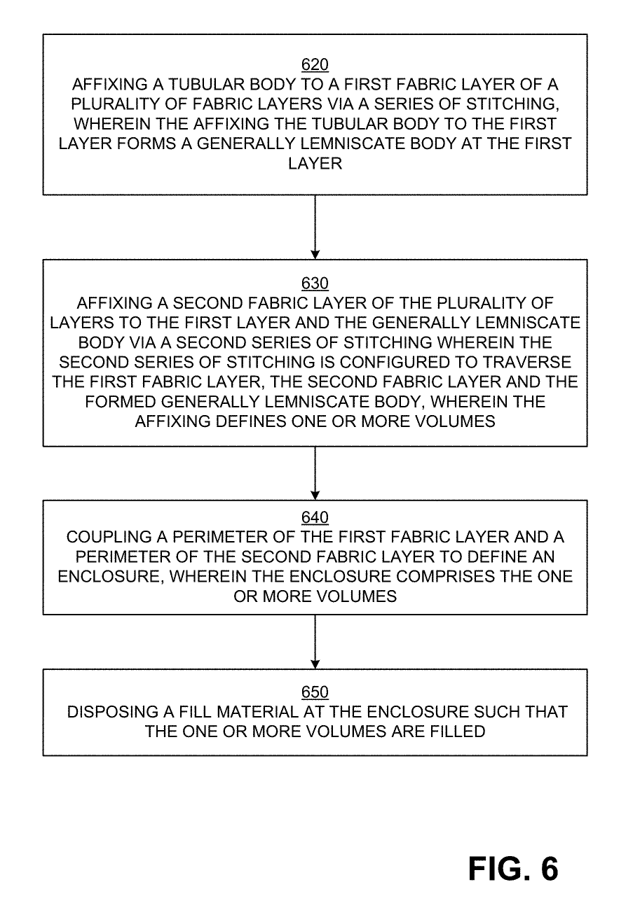

The present disclosure also provides methods of forming the disclosed quilted construction. FIG. 6 is a schematic diagram illustrating an exemplary method. The method may comprise affixing a tubular body to a first fabric layer of a plurality of fabric layers via a series of stitching at 620. The affixing the tubular body to the first layer forms a generally curvilinear cross-sectional body (figure-eight) from the tubular body at the first layer. At 630, a second fabric layer may be affixed to the first layer and the generally curvilinear cross-sectional body using a second series of stitching. The second series of stitching may be configured to pass through, or traverse, the first fabric layer, the second fabric layer, and the formed generally curvilinear cross-sectional body. The fabric layers, first and second series of stitching, and the generally curvilinear cross-sectional body cooperate to define a volume. At 640, a perimeter of the first layer and a perimeter of the second layer may joined to form an enclosure, wherein the enclosure includes the volume. A fill material may be deposited at the enclosure such that at least a portion of the volume is filled at 650.

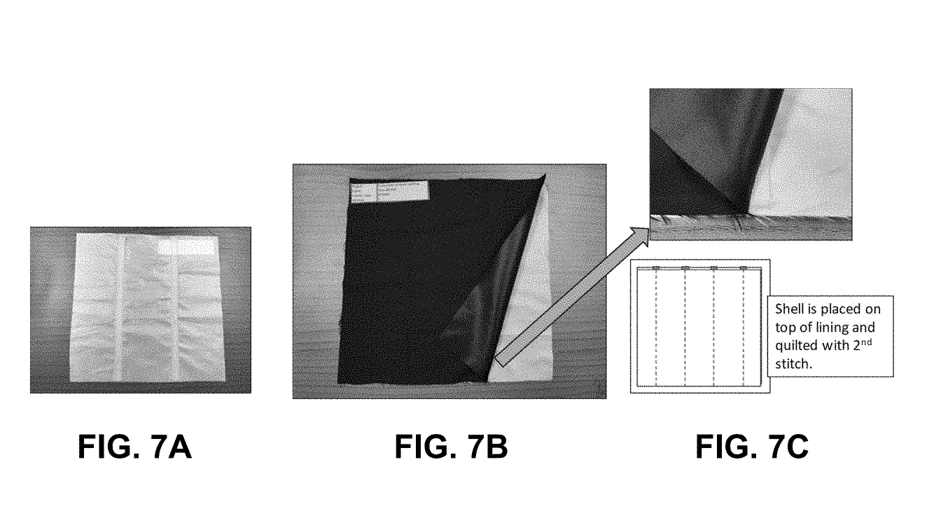

FIGS. 7A-7C are images illustrating selected steps of the disclosed method. FIG. 7A shows the reinforcing body affixed to the first layer via a series of stitches. FIG. 7B shows the second layer (a shell) affixed to the reinforcing body and the first layer via a second series of stitches. A section of the second layer is folded back to show the affixed reinforcing body. FIG. 7C shows an enlarged view of the first and second layers affixed to the reinforcing body via stitching.

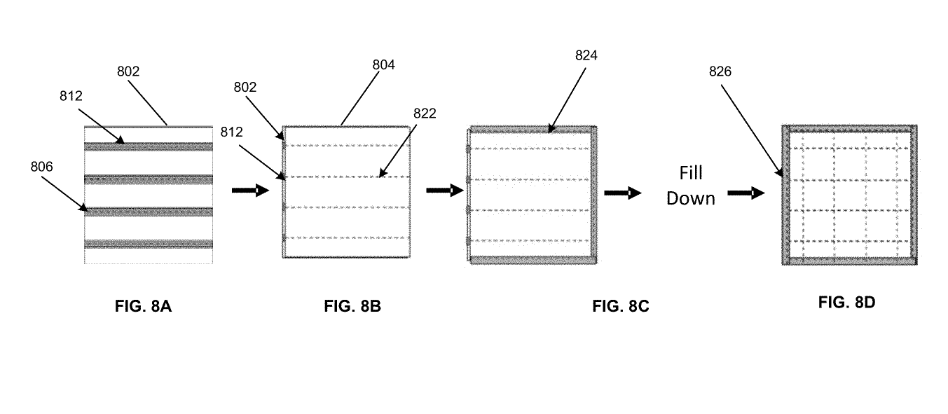

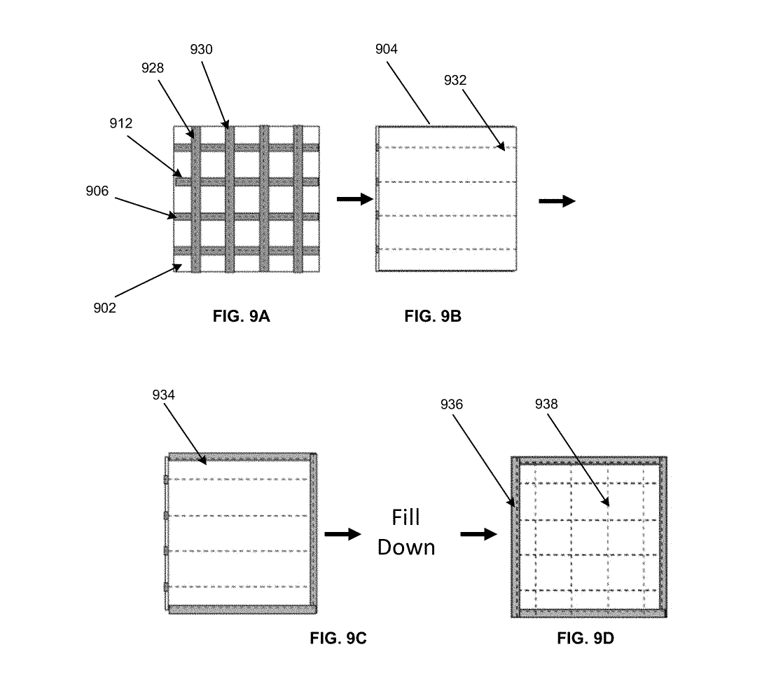

Suitable garment fabrication methods incorporating the quilted construction provided herein may be known to those of ordinary skill in the art. The disclosed quilted construction may be applied in a number variations. For example, FIGS. 8 and 9 are schematic diagrams of the method steps for a quilted construction according to a parallel chamber configuration and a checkerboard chamber configuration, respectively. FIG. 8A shows the reinforcing body 812 affixed to the first layer 802 via a series of stitching 806. The series of stitching 806 and reinforcing bodies 812 are disposed at the first layer 802 in a repeating parallel pattern. A second layer 804 is affixed to the first layer 802 and the reinforcing body 812 via a second series of stitching 822 in FIG. 8B. The second series of stitching 822 defines one or more chambers between the first and second layers. A portion of a perimeter of the first and second layers is joined to form an enclosure via at least a third series of stitching 824 in FIG. 8C. The enclosure may encompass the one or more chambers. Fill material is disposed at the enclosure and the remaining perimeter is joined in FIG. 8D via at least a fourth series of stitching 826.

FIG. 9A shows the reinforcing body 912 affixed to the first layer 902 via a series of stitching 906. The series of stitching 906 and reinforcing bodies 912 are disposed at the first layer 902 in a repeating lattice or checkerboard pattern. For example, a first series of stitching 906 and reinforcing bodies 912 may be applied in a first repeating parallel pattern at the first layer 902. A second series of stitches 928 and reinforcing bodies 930 may be affixed at the first layer 902 in a second repeating parallel pattern that is orthogonal or perpendicular to the first repeating parallel pattern. A second layer 904 is affixed to the first layer 902 and the reinforcing body 912 via a third series of stitching 932 in FIG. 9B. The third series of stitching 932 defines one or more chambers between the first and second layers 902, 904. A portion of a perimeter of the first and second layers is joined to form an enclosure via at least a fourth series of stitching 934 in FIG. 9C. The enclosure may encompass the one or more chambers. Fill material is deposited at the enclosure and the remaining perimeter may be joined in FIG. 9D via at least a fifth series of stitching 936. A sixth series of stitching 938, aligning or overlapping with the first series of stitching, may be used to complete the lattice pattern on the enclosure also shown in FIG. 9D.

For lighter weight fabrics or complex stitching patterns (i.e., curves as in Appendix B, overlapping design as in FIGS. 9A-9D), the present quilted construction may be particularly useful. The reinforcing body described herein may prevent, reduce, or limit, down leakage at the stitching of a quilted construction or quilted garment. As described above, the reinforcing body having a generally figure-eight form has a pair of lobes oriented along the plurality of stitches in the garment construction. When a fill material is added to the chambers of the construction, these lobes may be forced against the stitching. The forcing action may apply a pressure at the stitching and may block at least a portion of the fill material from escaping from the quilt stitching needle holes. Further, as the reinforcing body may be a mesh and possibly light in color, the reinforcing body may be inconspicuous at the quilt stitching and may have effect on hand-feel at the quilt stitching of the garment. In various aspects, the construction may exhibit less down leakage along its quilt stitching than exhibited by a substantially similar construction having a first pliable sheet material, a second pliable sheet material and a fill material in the absence of a reinforcing body when tested using adhesive tape to evaluate released fill material after five wash cycles. The construction may comprise, for example, but not to be limiting, an item of apparel, a sleeping bag, a comforter, a pillow, a pad, or a cushion.

The textiles usable in the inventive subject matter may be made from any suitable material, including synthetic materials (e.g., polyester, nylon), natural materials (e.g., cotton or wool), or combinations thereof. Fabrics may be joined together by sewing, stitching, seamless weaving or knitting, adhesive bonding, melting or welding or any other known technique for fixing pieces of fabric together. As noted, constructs of the inventive subject matter can be used in a variety of fabric articles. It is particularly directed to certain articles incorporating the insulation or cushioning constructs. The constructs include any range of articles where such constructs may be used, including in garments and apparel, e.g., insulated jackets and pants; gloves; footwear, e.g., shoes and socks; headwear, e.g., parka hoods and other insulated hats, and facemasks; outdoor equipment, e.g., sleeping bags and shells for sleeping bags, blankets, tents, tarps and other covers; bedding, pillows, cushions, upholstery, or other fabric and non-fabric articles that can benefit from thermal insulation or cushioning.

As used herein, “sewn through,” also called stitch-through, refers to a quilting construction technique. In sewn-through layers, layers (such as a shell and liner) are pinched and stitched directly together to join the two layers. Sewn-through may be achieved using an embroidery machine or automatic quilting machine, for example. There is typically no vertical wall (baffle) between layers, though the individual channels of down may be commonly referred to as baffles.

As used herein, a “construction” may refer to an item or article formed from a material such as a fabric or woven textile. The construction may be formed by combining or adjoining separate materials pieces via stitches, for example, or other suitable means of attachment. Construction may relate to an item of apparel or clothing or a garment and the materials that may form them such as fabric, stitching, and/or insulating materials.

As used herein, “generally figure-eight” with respect to a form or body (such as a reinforcing body) indicates that a shape of the form or body approximates the shape of the Arabic numeral eight in form or shape. A figure-eight shape may be characterized by two loops or lobes formed by a continuous line that crosses itself. In some aspects, the figure-eight shape may be apparent at a lateral cross-section of the reinforcing body.

As used herein, “generally parallel” with respect to layers indicates that layers may extend generally or approximately in the same direction but deviation from exactly parallel may be presumed.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” “aspects,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

The following exemplary embodiments are provided so that the present disclosure will be thorough and fully convey the scope to those skilled in the art. Numerous specific details are set forth such as examples of specific components, devices and schematic configurations to provide a thorough understanding of exemplary embodiments of the present disclosure. However, it will be apparent to those skilled in the art that these specific details need not be employed, that the exemplary embodiments may be embodied in many different forms, and that neither should be construed to limit the scope of the present disclosure.

In various aspects, the present disclosure may pertain to one or more of the following examples.

### Example 1

A construction comprising: a first layer; a second layer disposed adjacent the first layer such that the second layer is generally parallel to the first layer; a tubular insert disposed between the first layer and the second layer; and a plurality of stitches configured to join at least a portion of the first layer to at least a portion of the second layer, wherein at least a portion of the plurality of stitches pass through the tubular insert such that the tubular insert forms a curvilinear cross-sectional body, and wherein the plurality of stitches, the first and second layers, and the curvilinear cross-sectional body define a plurality of chambers between the first layer and the second layer; and a thermal insulation material disposed within the plurality of chambers.

### Example 2

The construction of example 1, wherein the first layer or the second layer or both comprise a fabric.

### Example 3

The construction of example 1, wherein the first layer or the second layer or both comprise a woven material.

### Example 4

The construction of any one of examples 1-3, wherein the tubular insert comprises a sufficiently pliable material that allows the tubular insert to form a curvilinear cross-sectional body as the at least a portion of the plurality of stitches pass therethrough.

### Example 5

The construction of any one of examples 1-, wherein the tubular insert comprises a mesh.

### Example 6

The construction of any one of examples 1-, wherein the tubular insert comprises a nylon mesh.

### Example 7

The construction of any one of examples, wherein the construction comprises an item of apparel, a sleeping bag, a comforter, a pillow, a pad, or a cushion.

### Example 8

A fabric structure comprising: a first woven sheet; a second woven sheet; a series of stitching affixing at least a portion of the first woven sheet to a portion of the second woven sheet and defining one or more chambers between the first woven sheet and the second woven sheet; a reinforcing body having a figure-eight form, wherein the reinforcing body is disposed between the first woven sheet and second woven sheet such that a crossover of the figure-eight form is aligned with the series of stitching; and a thermal insulating filler disposed within the one or more chambers.

### Example 9

The fabric structure of example 8, wherein the reinforcing body comprises a pliable material.

### Example 10

The fabric structure of example 8, wherein the reinforcing body comprises a mesh.

### Example 11

The fabric structure of example 8, wherein the reinforcing body comprises a nylon mesh.

### Example 12

The fabric structure of any of examples 8-11, wherein the series of stitching comprises quilt stitching.

### Example 13

The fabric structure of any of examples 8-12, wherein the thermal insulating filler comprises down, poly-fill, fiber ball, or a combination thereof.

### Example 14

A method of quilting comprising: affixing a tubular body to a first fabric layer of a plurality of fabric layers via a series of stitching, wherein the affixing the tubular body to the first layer forms a generally curvilinear cross-sectional body at the first layer; affixing a second fabric layer of the plurality of layers to the first layer and the generally curvilinear cross-sectional body via a second series of stitching wherein the second series of stitching is sewn through the first fabric layer, the second fabric layer and the formed generally curvilinear cross-sectional body, wherein the fabric layers, series of stitching, and generally lemniscate body define a volume; and joining at least a portion of a perimeter of the first layer and a perimeter of the second layer to form an enclosure, wherein the enclosure comprises the volume; and depositing a fill material at the enclosure such that at least a portion of the volume is filled.

### Example 15

A garment comprising: a first pliable sheet-like structure; a second pliable sheet-like structure disposed adjacent the first pliable sheet-like structure, wherein the second pliable sheet-like structure is coupled to the first pliable sheet-like structure via stitching; one or more generally figure-eight cross-sectional bodies disposed between the first sheet-like structure and the second sheet-like structure wherein the generally figure-eight cross-sectional body is affixed to the first sheet-like structure and the second sheet-like structure via stitching, wherein the first sheet-like structure, the second sheet-like structure, and the one or more generally figure-eight cross-sectional bodies form a plurality of chambers, wherein the stitching forms a cross-over of the generally figure-eight cross-sectional body; and a thermal insulating material disposed in at least a portion of the chambers of the plurality of chambers.

### Example 16

The garment of example 15, wherein the pliable sheet-like structures comprise thermoplastic fibers.

### Example 17

The garment of example 15, wherein the pliable sheet-like structures comprise a polyester.

### Example 18

The garment of any of examples 15-17, wherein the generally figure eight body comprises mesh.

### Example 19

The garment of any of examples 15-17, wherein the generally figure-eight cross-sectional body comprises a nylon mesh.

### Example 20

The garment of any of examples 15-19, wherein the thermal insulating material comprises down.

### Example 21

The garment of any of examples 15-19, wherein the thermal insulating material comprises down, poly-fill, fiber ball, or a combination thereof.

### Example 22

The garment of any of examples 15-21, wherein the generally figure-eight cross-sectional body and thermal insulating material cause a sealing force at the stitching.

### Example 23

The garment of any of examples 15-21, wherein the thermally insulating material causes lobes of the generally figure-eight cross-sectional body to apply a sealing force at the stitching.

### Example 24

The garment of any of examples 15-23, garment exhibits less down leakage than a substantially similar garment having a first pliable sheet-like structure, a second pliable sheet-like structure and a thermal insulating material in the absence of a generally figure-eight cross-sectional body when tested using adhesive tape to evaluate released thermal insulating material after five wash cycles.

### Example 25

A construct, comprising: a first pliable sheet material opposite to a second pliable sheet material, a series of stitching joining the first pliable sheet material to the second pliable sheet material, wherein the series of stitching defines a volume for receiving a loose fill material; a reinforcing body disposed at the series of stitching and between the first pliable sheet material and the second pliable sheet material, wherein the reinforcing body has a curvilinear cross-sectional form; and a fill material within the volume.

### Example 26

The construct of example 25, wherein the first pliable sheet material or the second pliable sheet material or both comprise a fabric.

### Example 27

The construction of example 25, wherein the first pliable sheet material or the second pliable sheet material or both comprise a woven material.

### Example 28

The construction of any one of examples 25-27, wherein the reinforcing body comprises a sufficiently pliable material.

### Example 29

The construction of any one of examples 25-27, wherein the reinforcing body comprises a mesh.

### Example 30

The construction of any one of examples 25-27, wherein the reinforcing body comprises a nylon mesh.

### Example 31

The construction of any one of examples 25-30, wherein the construction comprises an item of apparel, a sleeping bag, a comforter, a pillow, a pad, or a cushion.

### Example 32

The construction of any one of examples 25-31, wherein the construction exhibits less down leakage than a substantially similar construction having a first pliable sheet material, a second pliable sheet material and a fill material in the absence of a reinforcing body when tested using adhesive tape to evaluate released fill material after five wash cycles.

### Example 33

The construction of any one of examples 25-32, wherein the series of stitching is formed by an embroidery machine or device.

### Example 34

A stitching reinforcement device comprising: a tubular body, wherein the tubular body is configured to be affixed between parallel fabric layers, wherein the tubular body is affixed via stitching so that when the tubular body is disposed between the parallel fabric layers the tubular body assumes a generally figure-eight cross-sectional body, wherein a cross-section of the figure-eight cross-sectional is aligned with the stitching joining the fabric layers.

### Example 35

The stitching reinforcement device of example 34, wherein the stitching reinforcement device comprises a pliable material.

### Example 36

The stitching reinforcement device of example 34, wherein the stitching reinforcement device comprises a mesh.

### Example 37

The stitching reinforcement device of example 34, wherein the stitching reinforcement device comprises a nylon mesh.

### Example 38

A construction comprising: a first layer; a second layer disposed adjacent the first layer such that the second layer is generally parallel to the first layer; a plurality of tubular inserts disposed between the first layer and the second layer; and a plurality of stitches configured to join at least a portion of the first layer to at least a portion of the second layer, wherein at least a portion of the plurality of stitches pass through the plurality of tubular inserts such that the plurality of tubular inserts form a plurality of curvilinear cross-sectional bodies, and wherein the plurality of stitches, the first and second layers, and the plurality of curvilinear cross-sectional bodies define a plurality of chambers between the first layer and the second layer; and a thermal insulation material disposed within the plurality of chambers.

### Example 39

The construction of any of examples 1-7, wherein the tubular insert and thermal insulation material cause a sealing force at the plurality of stitches.

### Example 40

The construction of any of examples 1-7, wherein the construction exhibits less down leakage than a substantially similar garment having a first layer, a second layer, a plurality of stitches, and a thermal insulation material in the absence of a tubular insert when tested using adhesive tape to evaluate released thermal insulation material after five wash cycles of the construction.

### Example 41

The fabric structure of any of examples 8-13, wherein the reinforcing body and thermal insulating filler cause a sealing force at the series of stitching.

### Example 42

The fabric structure of any of examples 8-13 or 42, wherein the fabric structure exhibits less down leakage than a substantially similar fabric structure having a first woven sheet, a second woven sheet, a series of stitching, and a thermal insulating filler in the absence of a reinforcing body when tested using adhesive tape to evaluate released thermal insulating material after five wash cycles of the fabric structure.

### Example 43

The method of quilting of example 14, wherein the tubular body comprises a mesh material.

### Example 44

The method of quilting of example 14 or 43, wherein a quilted article formed according to the method exhibits less down leakage than a substantially quilted article having a plurality of fabric layers, a series of stitching, and a fill material in the absence of a tubular body when tested using adhesive tape to evaluate released thermal insulating material after five wash cycles of the quilted article.

### Example 45

A construction comprising: a first layer; a second layer disposed adjacent the first layer such that the second layer is generally parallel to the first layer; a tubular insert disposed between the first layer and the second layer; and a plurality of stitches configured to join at least a portion of the first layer to at least a portion of the second layer, wherein at least a portion of the plurality of stitches pass through the tubular insert such that the tubular insert forms a curvilinear cross-sectional body, and wherein the plurality of stitches, the first and second layers, and the curvilinear cross-sectional body define a plurality of chambers between the first layer and the second layer; and a thermal insulation material disposed within the plurality of chambers.

### Example 46

The construction of examples 45, wherein the first layer or the second layer or both comprise a fabric.

### Example 47

The construction of examples 45, wherein the first layer or the second layer or both comprise a woven material.

### Example 48

The construction of examples 45-47, wherein the tubular insert comprises a sufficiently pliable material that allows the tubular insert to form a curvilinear cross-sectional body as the plurality of stitches pass there through.

### Example 49

The construction of examples 45-48, wherein the tubular insert comprises a mesh.

### Example 50

The construction of examples 45-48, wherein the tubular insert comprises a nylon mesh.

### Example 51

The construction of examples 45-50, wherein the construction comprises an item of apparel, a sleeping bag, a comforter, a pillow, a pad, or a cushion.

### Example 52

The construction of examples 45-51, wherein the tubular insert and thermal insulation material cause a sealing force at the plurality of stitches.

### Example 53

The construction of examples 45-52, wherein the construction exhibits less down leakage than a substantially similar garment having a first layer, a second layer, a plurality of stitches, and a thermal insulation material in the absence of a tubular insert when tested using adhesive tape to evaluate released thermal insulation material after five wash cycles of the construction.

### Example 54

The construction of examples 45-53, wherein the thermal insulating filler comprises down, poly-fill, fiber ball, or a combination thereof

### Example 55

A garment, wherein at least a portion of the garment is formed from the construction of examples 45-55.

### Example 56

A garment, wherein at least a portion of the garment is formed from the first layer, second layer, the tubular insert, the plurality of stitches, and the thermal insulation of any of examples 45-55.

### Example 57

The construction of any of examples 45-55, wherein the series of stitching comprises quilt stitching.

### Example 58

A method of quilting comprising: affixing a tubular body to a first fabric layer of a plurality of fabric layers via a series of stitching, wherein the affixing the tubular body to the first layer forms a generally curvilinear cross-sectional body at the first layer; affixing a second fabric layer of the plurality of layers to the first layer and the generally curvilinear cross-sectional body via a second series of stitching wherein the second series of stitching is sewn through the first fabric layer, the second fabric layer and the formed generally curvilinear cross-sectional body, wherein the fabric layers, series of stitching, and generally figure-eight body define a volume; and joining at least a portion of a perimeter of the first layer and a perimeter of the second layer to form an enclosure, wherein the enclosure comprises the volume; and depositing a fill material at the enclosure such that at least a portion of the volume is filled.

### Example 59

The method of quilting of example 58, wherein the tubular body comprises a mesh material.

### Example 60

The method of quilting of any of examples 57-58, wherein a quilted article formed according to the method exhibits less down leakage than a substantially quilted article having a plurality of fabric layers, a series of stitching, and a fill material in the absence of a tubular body when tested using adhesive tape to evaluate released thermal insulating material after five wash cycles of the quilted article.

### Example 61

A fabric structure comprising: a first woven sheet; a second woven sheet; a series of stitching affixing at least a portion of the first woven sheet to a portion of the second woven sheet and defining one or more chambers between the first woven sheet and the second woven sheet; a reinforcing body having a figure-eight form, wherein the reinforcing body is disposed between the first woven sheet and second woven sheet such that a crossover of the figure-eight form is aligned with the series of stitching; and a thermal insulating filler disposed within the one or more chambers.

### Example 62

The fabric structure of example 61, wherein the reinforcing body comprises a pliable material.

### Example 63

The fabric structure of example 61, wherein the reinforcing body comprises a mesh.

### Example 64

The fabric structure of any of examples 61-62, wherein the thermal insulating filler comprises down, poly-fill, fiber ball, or a combination thereof.

### EXAMPLES

The following examples are put forth so as to provide those of ordinary skill in the art with a complete disclosure and description of how the articles, devices and/or methods claimed herein are made and evaluated, and are intended to be purely exemplary and are not intended to limit the disclosure.

Three pillows were prepared. Pillow 1 (P1) was prepared using a conventional quilting method. That is, a quilted layers were formed and filled without down fiber fill. Pillows 2 (P2) and 3 (P3) were prepared using the quilted construct of the present disclosure and including a tubular insert comprising mesh. P2 and P3 differed according to the weight of the mesh. P2 was a Vilene ME9601 mesh and P3 was a Vilene ME9201 mesh. The pillows were subjected to five wash cycles. Adhesive tape was then applied at the stitching to gather down leakage. FIGS. 8A-8C are images of the tape observed for at P1 (FIG. 8A), P2 (FIG. 8B), and P3 (FIG. 8C). From a visual inspection, P1 using conventional stitching had the most down fiber fill on the adhesive tape. Between P2 and P3, P2 had less down fiber on the adhesive tape suggesting that P2 prevented more down leakage than P3.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A construction comprising:
a first layer;
a second layer disposed adjacent the first layer such that the second layer is generally parallel to the first layer;
a tubular insert disposed between the first layer and the second layer; and
a plurality of stitches configured to join at least a portion of the first layer to at least a portion of the second layer, wherein at least a portion of the plurality of stitches pass through the tubular insert such that the tubular insert forms a curvilinear cross-sectional body, and wherein the plurality of stitches, the first and second layers, and the curvilinear cross-sectional body define a plurality of chambers between the first layer and the second layer; and
a thermal insulation material disposed within the plurality of chambers.

2. The construction of claim 1, wherein the first layer or the second layer or both comprise a fabric.

3. The construction of claim 1, wherein the first layer or the second layer or both comprise a woven material.

4. The construction of claim 1, wherein the tubular insert comprises a sufficiently pliable material that allows the tubular insert to form a curvilinear cross-sectional body as the plurality of stitches pass there through.

5. The construction of claim 1, wherein the tubular insert comprises a mesh.

6. The construction of claim 1, wherein the tubular insert comprises a nylon mesh.

7. The construction of claim 1, wherein the construction comprises an item of apparel, a sleeping bag, a comforter, a pillow, a pad, or a cushion.

8. The construction of claim 1, wherein the tubular insert and thermal insulation material cause a sealing force at the plurality of stitches.

9. The construction of claim 1, wherein the construction exhibits less down leakage than a substantially similar garment having a first layer, a second layer, a plurality of stitches, and a thermal insulation material in the absence of a tubular insert when tested using adhesive tape to evaluate released thermal insulation material after five wash cycles of the construction.

10. The construction of claim 1, wherein the thermal insulating filler comprises down, poly-fill, fiber ball, or a combination thereof

11. A garment, wherein at least a portion of the garment is formed from the construction of claim 1.

12. A garment, wherein at least a portion of the garment is formed from the first layer, second layer, the tubular insert, the plurality of stitches, and the thermal insulation of any of claim 1.

13. The construction of claim 1, wherein the series of stitching comprises quilt stitching.

14. A method of quilting comprising:
affixing a tubular body to a first fabric layer of a plurality of fabric layers via a series of stitching, wherein the affixing the tubular body to the first layer forms a generally curvilinear cross-sectional body at the first layer;
affixing a second fabric layer of the plurality of layers to the first layer and the generally curvilinear cross-sectional body via a second series of stitching wherein the second series of stitching is sewn through the first fabric layer, the second fabric layer and the formed generally curvilinear cross-sectional body, wherein the fabric layers, series of stitching, and generally figure-eight body define a volume; and
joining at least a portion of a perimeter of the first layer and a perimeter of the second layer to form an enclosure, wherein the enclosure comprises the volume; and
depositing a fill material at the enclosure such that at least a portion of the volume is filled.

15. The method of quilting of claim 14, wherein the tubular body comprises a mesh material.

16. The method of quilting of claim 14, wherein a quilted article formed according to the method exhibits less down leakage than a substantially quilted article having a plurality of fabric layers, a series of stitching, and a fill material in the absence of a tubular body when tested using adhesive tape to evaluate released thermal insulating material after five wash cycles of the quilted article.

17. A fabric structure comprising:
a first woven sheet;
a second woven sheet;
a series of stitching affixing at least a portion of the first woven sheet to a portion of the second woven sheet and defining one or more chambers between the first woven sheet and the second woven sheet;
a reinforcing body having a figure-eight form, wherein the reinforcing body is disposed between the first woven sheet and second woven sheet such that a crossover of the figure-eight form is aligned with the series of stitching; and
a thermal insulating filler disposed within the one or more chambers.

18. The fabric structure of claim 17, wherein the reinforcing body comprises a pliable material.

19. The fabric structure of claim 17, wherein the reinforcing body comprises a mesh.

20. The fabric structure of claim 1, wherein the thermal insulating filler comprises down, poly-fill, fiber ball, or a combination thereof.
